(19) United States
(12) Patent Application Publication
(10) Pub. No.: US 2017/0109461 A1
(43) Pub. Date: Apr. 20, 2017

(54) System and Methods for Characterizing a Fabric or Material

(71) Applicant: DIMENSIONALMECHANICS, INC., BELLEVUE, WA (US)

(72) Inventors: RAJEEV DUTT, REDMOND, WA (US); SHAE HURST, SEATTLE, WA (US); JASON K. ELLIS, KIRKLAND, WA (US)

(21) Appl. No.: 15/295,549

(22) Filed: Oct. 17, 2016

Related U.S. Application Data
(60) Provisional application No. 62/243,513, filed on Oct. 19, 2015.

(51) Int. Cl. G06F 17/50; G06F 17/11

(52) U.S. Cl. CPC G06F 17/5009; G06F 17/11

(57) ABSTRACT

Embodiments of the inventive apparatus, including the associated data collection and processing methods, may be used to measure and evaluate various characteristics of a fabric or other material. Those characteristics may then be used directly or indirectly (such as after being subjected to further data processing, signal processing, machine learning, statistical analysis, etc.) to populate one or more parameters of a mathematical model of the fabric/material or a garment constructed from the same. Data obtained from operation of the inventive material scanner may be used to construct or refine mathematical models (such as by using data mining, curve fitting, or machine learning techniques) and/or provide values of one or more parameters used by existing models.

### CROSS REFERENCE TO RELATED APPLICATION

This application claims the benefit of U.S. Provisional Application No. 62/243,513, entitled “System and Methods for Characterizing a Fabric or Material,” filed Oct. 19, 2015, which is incorporated herein by reference in its entirety (including the Appendix) for all purposes.

### BACKGROUND

There are many situations where information about the physical properties of a material would be useful. These include, but are not limited to, the construction of new products, the creation of new solutions to recognized technical problems (e.g., the development of structures made from certain materials so that the structures exhibit certain desired mechanical or electrical properties, etc.), or the generation of physical or computational models of a material. For example, one might generate a simulation of how an object made from a certain material behaves under different conditions such as loading, climate, wind, movement, etc. This may be needed in order to determine if the material is suitable for a particular use or environmental conditions.

An example of this use case is simulating how a garment made from a material will look under different environmental and/or lighting conditions. Presenting this information to a potential customer may influence their decision to purchase the garment by allowing them to determine if the garment will satisfy their needs with regards to appearance in a location they expect to wear it, under the lighting conditions they expect to be in, as it moves on their body as they walk or run, etc. This and other uses cases may require detailed information regarding how a material behaves under different conditions, such as loading, wind, heat, lighting, moisture, etc.

Conventional approaches to modeling the behavior of materials typically suffer from one or more limitations that make them less desirable for use. These include, but are not limited to, an inability to model the appearance of the material with respect to a range of environmental conditions. These limitations often result from a lack of sufficient information about the mechanical and optical properties of a material that determine its response and appearance under different conditions.

Embodiments of the inventive system, apparatus, and methods are directed to addressing and solving these and other problems or disadvantages of conventional approaches to characterizing fabrics or other materials, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the inventive apparatus including the associated data collection and processing methods may be used to measure and evaluate various characteristics of fabric or other materials. Those characteristics may then be used directly or indirectly (such as after being subjected to further data processing, signal processing, machine learning, statistical analysis, etc.) to populate one or more parameters of a mathematical model of the fabric/material or a garment constructed from the same. Data obtained from operation of the scanner may be used to construct or refine mathematical models (such as by using data mining, curve fitting, or machine learning techniques) and/or provide values of one or more parameters used by existing models.

In one embodiment, the invention is directed to a system for characterizing a material, where the system includes:

one or more components operable to hold a sample of the material;

one or more components operable to apply a stress, torque, or a stretching force to the sample in a known manner and by an adjustable amount;

one or more components operable to determine an optical property of the sample, the one or more components including
a source for illuminating the sample; and
a detector operable to detect a resulting signal after interaction of a
signal from the source of illumination with the sample; and

one or more components operable to measure position or deflection of a location on the sample under the applied stress, torque, or stretching force.

In another embodiment, the invention is directed to a system for generating a visualization of an avatar representing a person wearing an article of clothing, where the clothing is fabricated at least in part from a material, and where the system includes
an apparatus for characterizing the material, the apparatus including
   one or more components operable to hold a sample of the material;
   one or more components operable to apply a stress, torque, or a stretching force to the sample in a known manner and by an adjustable amount;
   one or more components operable to determine an optical property of the sample, the one or more components including
      a source for illuminating the sample; and
      a detector operable to detect a resulting signal after interaction of a signal from the source of illumination with the sample; and
   one or more components operable to measure position or deflection of a location on the sample under the applied stress, torque, or stretching force; and
one or more electronic processors programmed to implement one or more of
   a process to perform data processing operations on the output of one or more of the detectors or sensors to convert the output or outputs into a format in which the processed data may be provided as an input to a model of the material;
   a process to perform data processing operations using the converted output or outputs and the model of the material to generate an electronic representation of the article of clothing;
   a process to perform data processing operations to generate an electronic representation of the person wearing the article of clothing; and
   a process to perform data processing operations to generate a visualization of the person wearing the article of clothing.

Other objects and advantages of the invention will be apparent to one of ordinary skill in the art upon review of the detailed description of the invention and the included figures.

### BRIEF DESCRIPTION OF THE DRAWINGS

Embodiments of the invention in accordance with the present disclosure will be described with reference to the drawings, in which:

FIG. 1 is a diagram illustrating an operational environment and computing architecture in which an embodiment of the inventive system and methods may be implemented;

FIGS. 2-6 illustrate and explain certain aspects, elements, functions, operations, and processes of an embodiment of the inventive material or fabric measurement and characterization system, where:

FIG. 2 is a diagram illustrating a possible system architecture that may be used to implement an embodiment of the inventive system and methods;

FIG. 3 is a diagram illustrating a mechanism that may be used to clamp and apply forces to a piece of material as part of an implementation of an embodiment of the inventive system and methods;

FIG. 4 is a diagram illustrating a mechanism that may be used to collect data regarding the impact of an applied force on a piece of material as part of an implementation of an embodiment of the inventive system and methods;

FIG. 5 is a diagram illustrating certain of the optical properties of a piece of material or fabric that may be measured or determined as part of an implementation of an embodiment of the inventive system and methods;

FIG. 6 is a diagram illustrating the measurement of the optical properties of a piece of material or fabric relating to its specularity/anisotropy that may be measured as part of an implementation of an embodiment of the inventive system and methods;

FIG. 7(a) is a diagram illustrating a possible data structure that may be used to implement an embodiment of the inventive system and methods;

FIG. 7(b) is a diagram illustrating another possible data structure that may be used to implement an embodiment of the inventive system and methods; and

FIG. 8 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described herein with the specificity required to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or any other suitable form. The following detailed description is, therefore, not to be taken in a limiting sense.

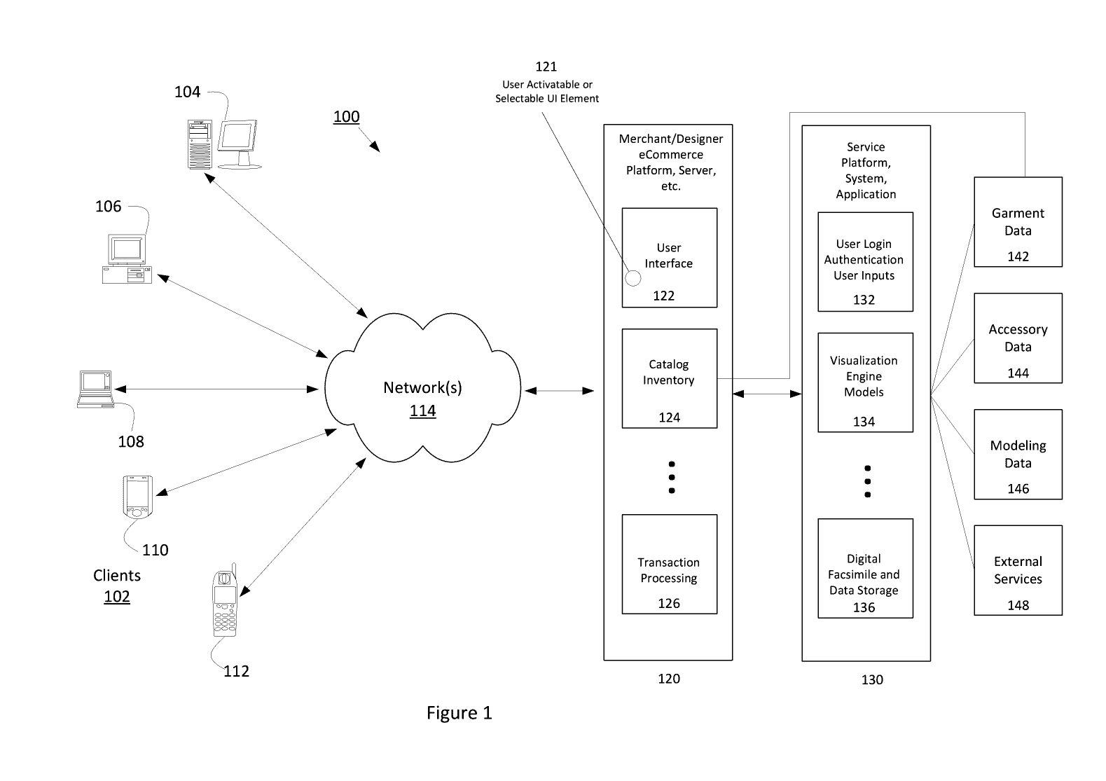

Embodiments of the inventive material or fabric scanner may be used to acquire data and information regarding the physical properties and behavior of a material, fabric, substrate, surface, etc. This data and information may then be used to set one or more parameters of a model or process that is used to determine the appearance of an article constructed from the material, fabric, substrate, surface, etc., and also (if desired) how the article responds to different environmental conditions (such as lighting, moisture, wind, background, etc.). One example of such a use case is that of a system that generates realistic images of clothing or other items manufactured from a material or fabric. An example of such a system is described further with reference to FIG. 1; however, it should be understood that an embodiment of the inventive scanning or material characterization system may be used for other purposes where information about the physical properties of a material is needed to better characterize an item or structure constructed from that material.

FIG. 1 is a diagram illustrating an operational environment or computing architecture 100 in which (or with which) an embodiment of the inventive system and methods may be implemented. As shown, a variety of clients 102 incorporating and/or incorporated into a variety of computing devices may communicate with a server 120 hosting a web-page or application through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 108, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e.g., the Internet).

A user may communicate with server 120 using a browser or other application. Such a browser or application will typically use a URL or other form of “address” to submit a request to server 120 for a particular web-page. Server 120 may be operated by or for a merchant, business, or other form of organization and may be part of a data processing system or platform (such as a business data processing platform that includes capabilities for processing inventory related data, sales data, business resource data, etc.).

In some embodiments of the inventive system and methods, server 120 may be associated with or part of an eCommerce platform or system that provides and manages an eCommerce web-site for a merchant or retailer. In such embodiments, server 120 (or the equivalent system or platform) may include one or more functional elements or modules, including (but not limited to, or required to include) a user interface 122 module, a catalog/inventory module 124, and a transaction processing module 126. User interface module 122 may include software instructions that, when executed by a suitable processing element, operate to generate and display one or more activate-able elements, display elements, form fields, data entry elements or regions, buttons, selectable elements, etc. In some embodiments, user interface 122 may include a selectable and/or activate-able button or other element 121, which permits a user to initiate or rejoin a “session” of the visualization and other services provided by the inventive system and methods.

Catalog or Inventory module 124 may include software instructions that, when executed by a suitable processing element, operate to manage and provide access to data representing the merchant's or designer's catalog of products. Such data may include text, images, video, and other forms of information (such as color, sizing, structure, fabric type, stylistic features, etc.). Catalog or Inventory module 124 may also include software instructions that, when executed by a suitable processing element, operate to manage certain inventory or inventory related functions or operations of the merchant's or designer's business, such as to update or revise inventory levels based on verified transactions, product in transit, product in storage, product on order, etc.

Transaction processing module 126 may include software instructions that, when executed by a suitable processing element, operate to manage the processing of a purchase transaction initiated by a customer. This may include providing functionality to enable a customer to provide payment for a purchase, to obtain authorization for the payment method, to arrange for customization, personalization, shipping, or other areas of fulfillment of the purchase, etc.

In some embodiments, when a customer/shopper activates or selects button or element 121, control may be transferred to the Service Platform, System, or Application 130 that is responsible for implementing certain of the functions, processes, methods, or operations associated with the inventive system and methods. Service Platform 130 may be implemented as a web-based or cloud-based service in accordance with one or more of several business models. Such business models may include (but are not limited to, or required to include) a subscription service, a single use service, etc.

Service Platform 130 may include a User Login and Authentication Module 132, which may be configured to accept one or more user inputs/credentials and in return authenticate a user and permit them to access the services and functionality of the platform 130. User Login and Authentication Module 132 may also permit a user to establish an account if they have not done so previously. The data entry functionality of User Login and Authentication Module 132 may enable a user to enter certain personal data (such as height, weight, age, etc.) that may be used to generate a digital facsimile representing the user.

Based at least in part on the information provided by the user (either contemporaneously, or during a previous session), Service Platform 130 may utilize one or more “models” of a person and/or a garment or accessory in order to generate a visualization of the user wearing one or more items. This may be accomplished by use of one or more “models” that are associated with Visualization Engine/Models module 134. Visualization Engine/Models module 134 may include software instructions, which when executed by a suitable processing element, are used to generate 2 or 3 dimensional representations of the user (with suitable customization or personalization, such as for hair color, hair style, body type, skin tone, makeup, age, etc.), of a specific garment (based on considerations of fabric type, garment style, stitching, fabric reflectivity, fabric movement or appearance under different environmental conditions (such as lighting, wind, shadowing, etc.)), or of a specific accessory (based on considerations of structure, material, reflectivity, etc.).

The models and associated methods or processes implemented by Visualization Engine/Models module 134 may be derived from considerations of physical properties, environmental conditions (altitude, wind, lighting, rain, etc.), scanning of a person or items, data mining of databases containing aggregate data for multiple persons of different age, weight, height, BMI, or other characteristics, etc. Data stores utilized in implementing embodiments of the inventive system and methods may be implemented with any suitable data storage technology, including structured query language (SQL) based relational database management systems (RDBMS).

Digital facsimile and Data Storage module 136 may be used to provide data storage of and access to the Digital facsimile and related data for a user, as well as for data related to specific items of clothing or accessories (which in some cases may have been customized or personalized for that user). By associating the Digital facsimile and other data with a specific user, that information may be shared with others at the user's direction (such as personal shoppers, designers, manufacturers, other retailers, etc.) and may also be used for other sessions in which the user wishes to visualize the same or a different item.

As suggested by Garment Data 142, Accessory Data 144, Modeling Data 146, and External Services 148, Service Platform 130 may be communicatively coupled to (or otherwise capable of message, instruction, and/or data exchange) with one or more services or data sources that are external to Service Platform 130. These may include data regarding Garments (such as characterizations or information regarding shape, patterns, fabric types, sizing, stylistic elements, etc., and may be provided by retailers and/or designers) or Accessories (such as characterizations or information regarding shape, materials, reflectivity, relative sizing, etc.). These external sources may also include Modeling Data 146 which may relate to improvements or extensions to mathematical/computational “models” used to generate certain aspects or characteristics of a person's Digital facsimile (such as to represent age related effects, changes in the relative distribution of weight or muscle, etc.) and/or of a Garment (such as to represent the effect of gravity, wind, motion, lighting, etc.). External Services 148 may represent sources of certain types of data processing, data mining, data analysis, machine learning, etc. that are utilized in generating a visualization, a recommendation, an estimated fit level for the garment, an estimated satisfaction level, or another aspect of the inventive system and methods.

### Fabric or Material Characterization

The following figures illustrate and explain certain aspects, elements, functions, operations, and processes of an embodiment of the inventive material or fabric measurement and characterization system.

As mentioned, in some embodiments, a “model” of a garment may include information to enable estimation of how the fabric and its attachments (seams, buttons, pocket flaps, etc.) will rest on a person, respond to environmental changes (lighting, wind, rain, etc.), and/or move as a person wearing the garment moves. In some embodiments, information about a garment and the material(s) from which it is constructed may be used to determine one or more parameters of a “fabric model”. In order to obtain at least some of this information, the inventors developed embodiments of the “fabric scanner” system and methods as described herein.

The scanner and its associated data collection and analysis methods may be used to measure and evaluate certain characteristics of a fabric or other material, with those characteristics being used directly or indirectly (such as after being subjected to further data processing, signal processing, machine learning, statistical analysis, etc.) to populate one or more parameters of a mathematical model for the fabric or for a garment constructed from the fabric. Note that the data obtained from operation of the scanner may be used to construct or refine a mathematical model (such as by using data mining, curve fitting, or machine learning techniques) and/or to provide one or more parameters or values that are used for purposes of populating an existing model.

The scanner/material characterization system may be used to determine certain physical properties of a material, fabric, substrate, etc., where those properties may be expressed in terms of one or more relevant parameters, such as density, tensile strength, susceptibility to deformation, reflectivity, etc. Such parameters/properties may be used as inputs to a model or characterization of a garment to provide a more accurate and realistic “prediction” or representation of how a garment will look and react under different environmental conditions (such as lighting, cloud cover, wind, moisture, movement by the person wearing the garment), etc. This provides a source of data for a visualization engine or other element that generates an image or representation of the garment, of a person wearing the garment, or of a person wearing the garment under specified environmental conditions (such as at the beach, in cloudy weather, in wind, etc.).

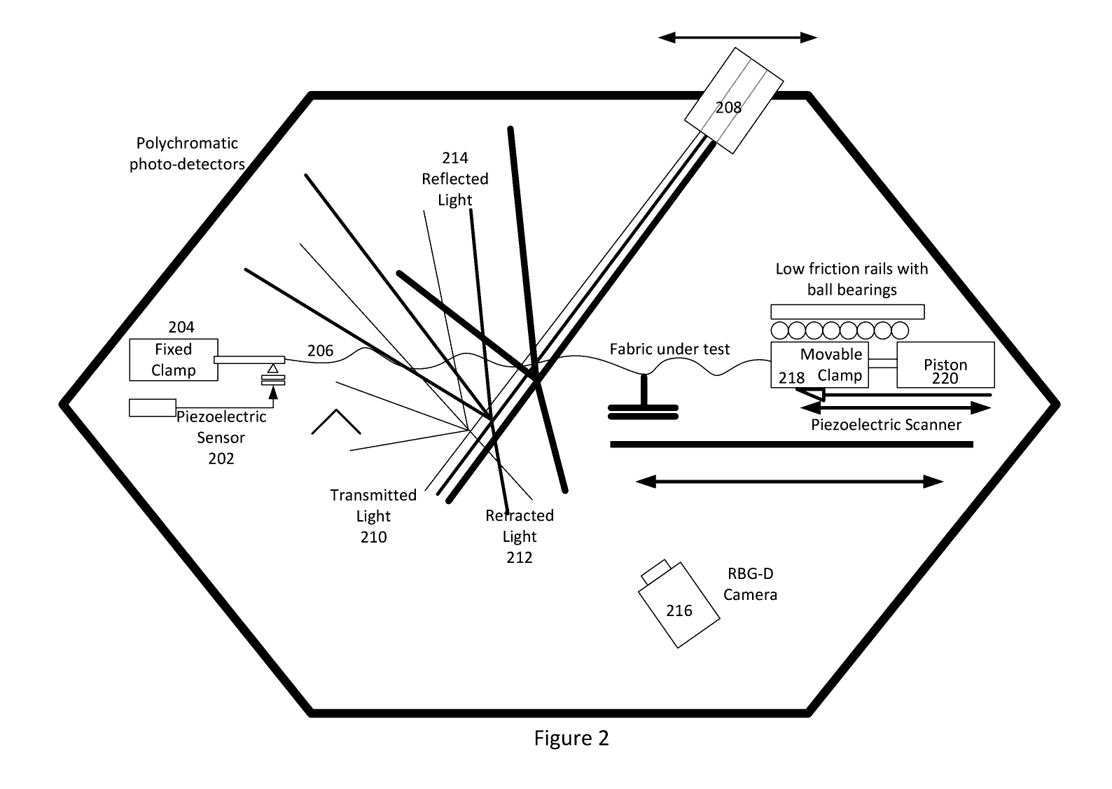

FIGS. 2-6 illustrate and explain certain aspects, elements, functions, operations, and processes of an embodiment of the inventive material or fabric measurement and characterization system. These diagrams illustrate components of (and methods of using) a fabric or material scanner or characterization system that may be used for measuring certain parameters or determining certain characteristics of a material. As described herein, such parameters or characteristics of a material may be used when developing a “model” of a garment or item constructed at least in part from the material, for purposes of generating a design, visualization, simulation, etc.

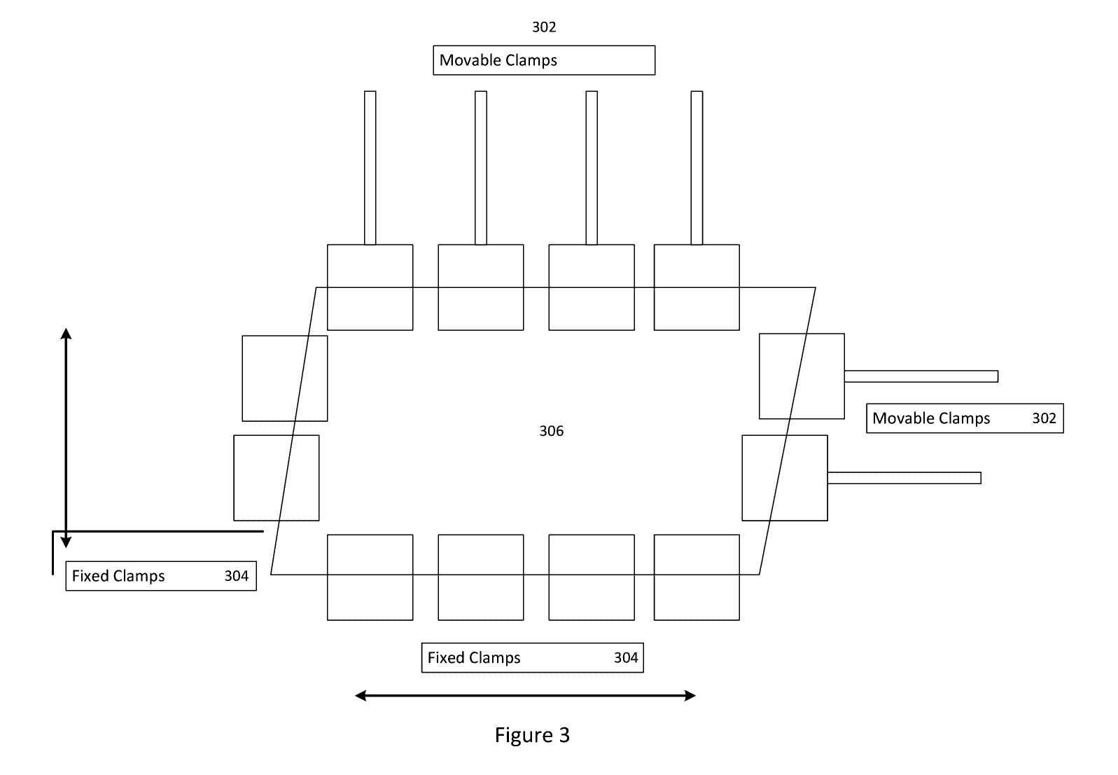

FIG. 3 is a diagram illustrating a mechanism that may be used to clamp and apply forces to a piece of material or fabric as part of an implementation of an embodiment of the material or fabric characterization system. As shown in the figure, one or more movable clamps (elements 302) may be used in conjunction with one or more fixed clamps (element 304) to properly position and hold a piece of fabric or other material (element 306) that is being analyzed.

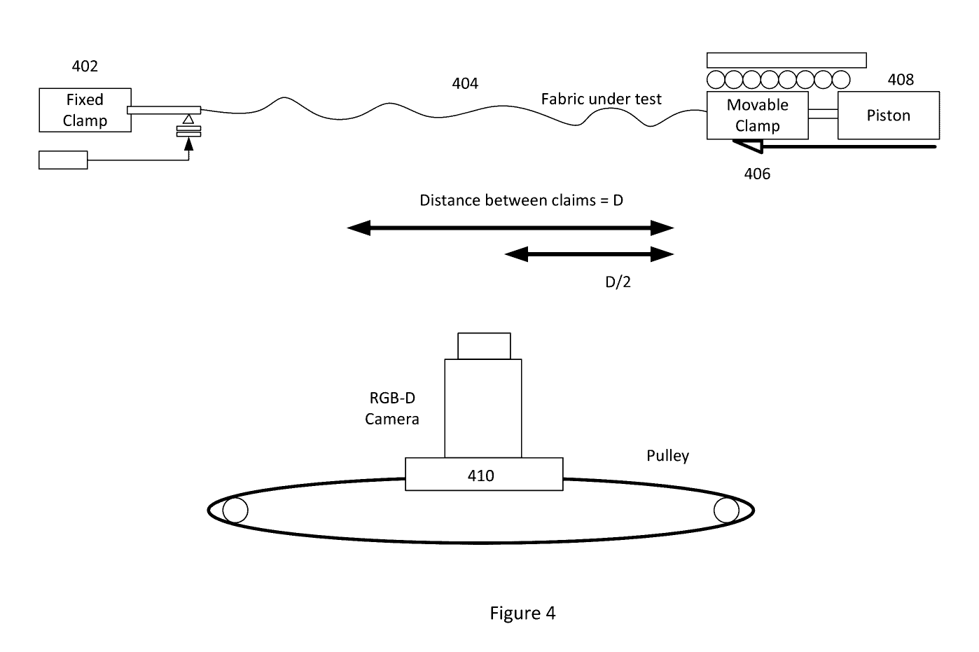

FIG. 4 is a diagram illustrating a mechanism or mechanisms that may be used to collect data regarding a section of fabric or material placed under a stretching, pulling or twisting force in order to determine the response of the fabric or material to that force. As shown in the figure, a fixed clamp 402 may be used to secure one end or the ends of the fabric under test 404. A movable clamp 406 may be used to secure the other end or end(s) of the fabric. Movable clamp 406 may be driven by a piston 408 or other suitable mechanism. An imaging device or camera 410 (such as a RGB-D camera) may be used to obtain precision images of the response of the fabric under test to the applied force or forces. These may be used to obtain measurements of the fabric's motion in response to the forces and ultimately to assist in populating the data structures that are generated by use of the inventive system and methods.

Note that in addition to shear, when characterizing a material/fabric, it may also be useful to measure the twist of the material/fabric in response to an applied torque; this information may be useful in modeling how apparel responds to being “bunched” or compressed. The twist or response to torque of a material/fabric may be obtained by marking grid points on the material/fabric, and measuring the strain on the material as it is twisted. In addition, the scanner may be used to measure the torque needed to produce a given twist (e.g., as expressed in terms of angular displacement, as in a torsion balance). When the material under application of a “twist” goes slack, the scanner can measure a wrinkle or wrinkles in the material (for example, linen). Similarly, the inventive scanner and associated elements or processes can be used to analyze folds or the interaction of different materials with each other.

In this measurement scenario, relaxing the clamps triggers a movable RGB-D camera 410, which is located half the distance between the clamps 402 and 406, to take a depth photograph of the material sagging. Using a suitable edge detection technique (e.g., Canny or Rothwell), the scanner may calculate the curvature of the sag to determine the material's “warp factor”. The scanner may also be able to determine the rigidity of the material.

In some embodiments, the scanner may use a high frequency sound wave as a source to measure the metallicity vs. dielectric properties of the material. For example, if the material has a relatively high reflectivity of sound waves, then it is a smooth, thick material (such as polished leather); if the material transmits sound, then it is a thin, smooth material (such as silk); if the material absorbs sound, then it is likely to be fluffy and therefore more a dielectric material. Sound reflectivity, transmission, and absorption can be correlated with measurements made by the optical system(s) of the scanner.

In one implementation (as suggested by FIG. 2), a piezoelectric sensor 202 is mounted on one or more fixed clamps 204 to enable measurement of waves that have propagated across the fabric under test 206; a wave generator may be located on the movable clamp. The wave generator produces a reference wave (of known amplitude and frequency) that can be changed as needed (for example, to characterize the material with regards to a cut-off point for wave propagation). The piezoelectric sensor(s) measure wave propagation velocity and the attenuation of the input wave/signal; the data may be recorded in terms of a relative signal strength reflected or scattered by a feature of the surface. A source of light (e.g., laser, LEDs, etc.) 208 is used to illuminate the fabric under test 206 that is held in place by the clamps 204. The interaction of the light with the fabric will produce components of one or more of transmitted light 210, refracted light 212, and reflected light 214. An imaging device such as a RGB camera 216 may be used to capture a multi-spectral image or images of the illuminated fabric. A movable clamp 218 (driven, for example, by a piston or actuator element 220) may be used to adjust the tension applied to the fabric or material.

In some embodiments, the elements, functions, and capabilities of the scanner or material characterization system may include the following functional elements or modules:

Material Friction Scanner (MFS)—this may be implemented by running a Teflon coated wedge shaped piezo-electric brush over the surface of the material. The intensity and frequency of the resulting signal is an indication of the “roughness” of the material and thus the friction. A second test is to run a calibrated block of a given material and then measure the resistance as the block is moved over the surface. By knowing the resistance and the calibrated coefficient of friction, comparisons can be made against a baseline material;
Material Stress & Strain System (MS3)—by pulling and tugging the material, it is possible to gauge the “elasticity” of the fabric—the force pulling against the fabric and resistance of the fabric against that force. The inventive scanner may perform this evaluation in the X, Y, and Z directions, resulting in data to populate a second order tensor field. The scanner can also calculate the ability of the material to “twist” and untwist by applying a given torque to the material and measuring the resistance to movement;
Material Density System (MDS)—the scanner can send a frequency pulse through a material that is stretched so that the state of stress matches a standard. A wave then propagates through the material. The dampening of the wave, as reflected by changes in wavelength, amplitude, or velocity can be measured using a piezoelectric sensor at another location on the material, and then compared against one or more sets of baseline data for materials. Silk, for example, does not significantly dampen the signal, while wool will dampen the signal. This measurement can be used to indicate how the material will “flutter” under different environmental conditions; or the “twirl” factor;
Material Thermal System (MTS)—although this is not used to calculate visible material properties, it could be useful in determining how well a material retains heat. This can be done by using a standard “candle” (such as a heat lamp) at a known power emission and then measuring the heat absorption on the other side of the material;

Using an RGB-D camera and an arrangement of lights and detectors, the system characterizes the optical properties of the material. These properties may include one or more of:
Color: this may be determined by shining lights on a material at different frequencies, measuring the reflected, transmitted, and scattered light from the material at different frequencies (and at different angles of incidence). The resulting data is used to construct a shader model for the material (allowing elements of its appearance under different lighting conditions to be modeled);
Transparency/Translucency: using the light arrangement described, the scanner can measure the amount of light transmitted through a material (as a function of frequency/color). This system can also measure the light refracted by the material. This data may also (or instead) be used in a particular shader model;
Albedo: the scanner can measure the absorption of light by the material, or its “velvet” properties. This is related to the amount of energy that is absorbed by the material at different frequencies, and may provide a component of a shader model; and
Texture: the camera can be used to provide an accurate image of the material texture, allowing calculation of normal maps and bump maps.

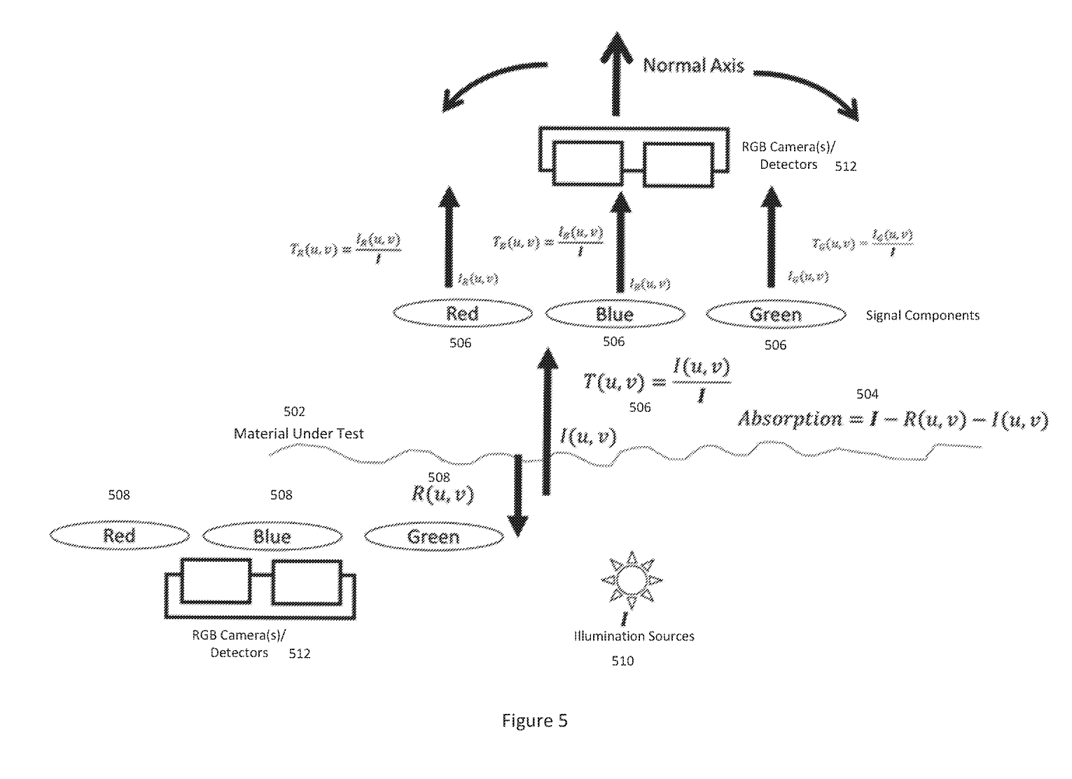

FIG. 5 is a diagram illustrating certain of the optical properties of a piece of material or fabric 502 that may be measured or determined as part of an implementation of an embodiment of the inventive system and methods. As shown in the figure, the material or fabric's components of absorption 504, transmission 506, and reflection 508 of light as measured at multiple wavelengths/colors (typically RGB) may be measured using a set of illumination sources 510 (e.g., lasers, LEDs, etc. of one or more wavelengths or wavelength bands) and one or more suitable sensors 512 (e.g., photodiodes, RGB-D cameras, etc.).

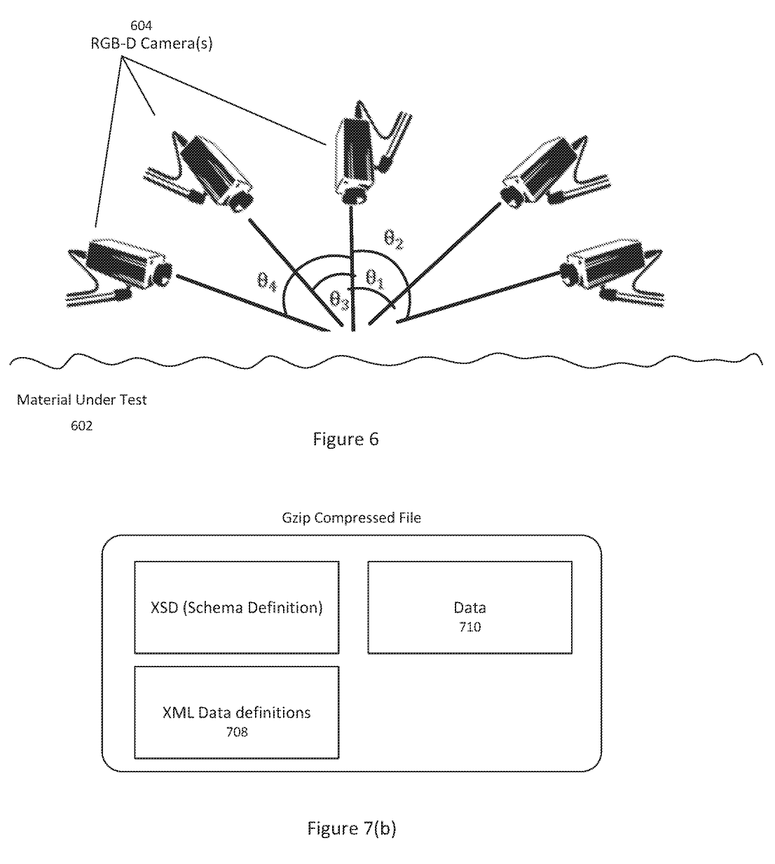

FIG. 6 is a diagram illustrating the measurement of the optical properties of a piece of material or fabric 602 relating to its specularity that may be measured as part of an implementation of an embodiment of the inventive system and methods. In this embodiment, multiple sensors (such as the illustrated multi-spectral RGB-D cameras 604) may be arranged to detect and make measurements of the light that is reflected by the surface of the material, as measured at different angles of reflection from the normal (illustrated as θ1, θ2, etc.). This data may be processed to provide an indication of the relative smoothness or roughness of the material.

### Example of the Operation of the Scanning Device

An example of a process or workflow for operating the scanning device is as follows (assuming that each component of the device has been calibrated, recalibrated, or it has been found that subsequent calibration is no longer necessary):
A swatch of cloth is attached by the user to fixed clamps on two edges that share a common corner; the opposite end of the fabric is connected to a moveable clamp;
The optical elements of the system illuminate and scan the material to measure optical and textural properties (e.g., color, opacity, reflection, granularity, etc., some or all of which may be used to characterize a material and distinguish it from other materials);
The appropriate system elements make measurements for purposes of determining the stress-strain tensor of the material;
The appropriate system elements may then be used to measure properties related to the sag of the material;
The appropriate system elements may then be used to measure properties related to the resistance of the material to sliding or moving against another material or object; and
If desired, certain thermal properties of a material may be determined based on measurements of heat transfer across or through a material, material density, etc.
   Note that seams and other boundaries can also be modeled or simulated by recording the impact of the seam on wave propagation, and stress and strain characteristics. As mentioned, a model of a garment may be created in a CAD system. Material zones and seams are then inserted into the CAD drawing. The material zones are parameterized based on the fabric being used for that portion of the garment. By knowing the relevant parameters at multiple points on the garment, users of the scanner can simulate the overall garment draped on a specific individual. Knowing the point stress and strain tensor along edges can be used to calculate downward forces against the person's flesh underneath the garment. This may factor into its comfort (e.g., its “itchiness”) or use in certain situations.

In one embodiment, the scanner or material analyzer operates to scan a piece of fabric or other material using a device similar to the one shown in FIGS. 2, 3 and 4 (note that FIG. 2 is a cross section, shown along the XZ axis; a similar set of elements is positioned along the YZ axis). RGB light bundles (not shown, but these may be implemented in the form of LED type emitter elements or another suitable source of illumination) are located in positions spaced along both the X axis and the Y axis. The light bundles are arranged, configured, and operable to illuminate the material, resulting in one or more of reflected, scattered, transmitted or refracted light after interacting with the material/fabric. The reflected, scattered, transmitted or refracted light may be detected by polychromatic sensors; the sensor outputs may be provided to one or more of a converter or data processing device which executes one or more signal processing applications. The signal processing applications are used to provide information related to the structure of the fabric and/or to its response to specific environmental conditions (lighting, wind, rain, stress, loading, etc.), or to changes in environmental conditions. This information may then be used as an input to a simulation or model of an item of apparel that is made from the fabric (where it is noted that simulating or modeling the item of apparel may involve additional data processing and/or modeling operations, such as to account for the impact of buttons, flaps, seams, etc.). Note that although the use of light bundles has been described, other sources of illuminating light (such as lasers) or even emitters operating at non-visual wavelengths (such as radar or acoustic emitters) may be used to gather relevant data regarding the response of a material. The emitters may produce a signal or source of illumination at a fixed wavelength or with a band of wavelengths.

In some embodiments, a piezoelectric sensor may be used to detect the characteristics of one or more of frequency, wavelength (based on the spacing of signals), or amplitude (based on the strength of a signal) of a physical wave propagating through the material; this information may be used to calculate the stress-strain tensor of the material. Another possible data collection scenario involves use of one or more of the clamps shown in the figures; in this situation, the clamp(s) are used to stretch the material to different (calibrated) distances along one or both of the X and Y-axis. This information may be used to determine the stress-strain tensor of the material. The thickness of the fabric can be measured by sensors in the clamps themselves that calculate how far apart the clamps are when tightened. Thickness may be an important parameter to measure because it can be used in simulations and impacts how a material behaves.

The scanner may be used to acquire data and information regarding the physical properties and behavior of a material, fabric, substrate, surface, etc. This data and information may then be used to set one or more parameters of a model or process that is used to determine the appearance of an article constructed from the material, fabric, substrate, surface, etc., and also (if desired) how the article responds to different environmental conditions (such as lighting, moisture, wind, background, eta). As described herein, one example of such a use case is that of a system that generates realistic images of clothing or other items manufactured from a material or fabric.

### Example Fields of Use of an Embodiment of the Inventive System

An embodiment of the inventive system and methods may be used for multiple design, manufacture, or simulation tasks. These include, but are not limited to, the following:
3D printing—using the laws of physics and certain optical properties, to create synthetic materials on the fly with the same digital properties;
Animation—to create realistic garments for animated characters, leading to an even greater degree of realism in appearance and behavior;
Gaming—realistic fabrics that obey the laws of physics—including being able to simulate bullets or other projectiles going through the material;
Design—scanning fabrics and using them in the design of garments;
Design of military equipment such as bullet-proof vests;
Design of sails for ships to create accurate physics of sails and to determine the tear point and other characteristics;
Spacecraft design—determining properties of fabrics used in solar sails;
Non-destructive art analysis—using optical properties and fabric properties to determine if an artwork is a forgery;
Forensic analysis—doing a deep digital scan of a material to be saved for detailed analysis later on; or
Measure aspects of a garment's “feel” against a wearer's skin; data useful for determining these may be obtained by using techniques such as ultrasound, air projection etc.

As mentioned, in addition to shear, when characterizing a material/fabric, it may also be useful to measure the twist of the material/fabric in response to an applied torque; this information may be useful in modeling how apparel responds to being “bunched” or compressed. The twist or response to torque of a material/fabric may be obtained by marking grid points on the material/fabric, and measuring the strain on the material as it is twisted. In addition, the scanner may be used to measure the torque needed to produce a given twist (e.g., as expressed in terms of angular displacement, as in a torsion balance). When the material under application of a “twist” goes slack, the scanner can measure a wrinkle or wrinkles in the material (for example, linen). Similarly, the inventive scanner and associated elements or processes can be used to analyze folds or the interaction of different materials with each other.

In one implementation, the scanner may use a high frequency sound wave to measure the metallicity vs. dielectric properties of the material. For example; if the material has a relatively high reflectivity of sound waves, then it is a smooth, thick material (such as polished leather); if the material transmits sound, then it is a thin, smooth material (such as silk); if the material absorbs sound, then it is likely to be fluffy and therefore more a dielectric material. Sound reflectivity, transmission, and absorption can be correlated with measurements made by the optical components of the system to relate observations made at different bandwidths to each other and to other properties of the material.

As mentioned, in one implementation, a piezoelectric sensor may be mounted on the fixed clamps to enable measurement of waves that have propagated across the fabric; a wave generator may be located on the movable clamp. The wave generator produces a reference wave (of known amplitude and frequency) that can be changed as needed (for example; to characterize the material with regards to a cut-off point for wave propagation). The piezoelectric sensor(s) measure wave propagation velocity and the attenuation of the input wave/signal; the data may be recorded in terms of a relative signal strength reflected or scattered by a feature of the surface.

To enable these uses, the inventive system may be used to determine or measure key aspects of a material that uniquely identifies the material or fabric in question. In this regard, the inventive system and methods may be used to measure or determine one or more of the following parameters, values, or characteristics:
Optical properties:
   At the simplest level, measure depth and pattern to get a reasonable first degree approximation of a material
      Depth to calculate normal, displacement or bump maps
      Surface pattern to determine a textile's visual appearance
   Additional properties that can be measured
      Diffusion
      Specularity
      Anisotropy
      Transparency/translucency by optical channel
      Velvet properties
      Albedo
      Polarization
      Metallicity
Physical properties
   Determining the stress & strain tensor
   Measuring wave propagation across the fabric
   Measuring the “tear point”
   Measuring roughness
      Note that there are other properties that may be useful later and that could be measured by the inventive system; these may include thermal properties, roughness, allergenic properties, water resistance etc.

In some use cases, a set of suitable optical and physical properties might be:

### Optical:

Surface pattern
Depth/bump data

### Physical:

Stress/Strain tensor values

### Measurement of Optical Properties—Transparency

To measure transparency, the device may be arranged as shown in FIG. 5 (which is a side view of an embodiment of the system). The system can measure the intensity of the incoming signal at various frequencies for example, red, green, blue (RGB). This should provide an indication of what % of light actually managed to make it through the material and at what frequency. Other properties of light can be measured; for example, if the above setup is replaced with or augmented by a polarization filter, the system can obtain measurements of light intensity at different polarizations. Albedo, a measure of the absorption, is obtained by removing the reflection and transparency components of the incident beam. Furthermore, by breaking the garment into a 2-dimensional lattice, the system can determine the specific transparency and reflection maps of the material over the surface, which can be used to construct the shader.

### Measurement of Optical Properties—Anisotropy

Certain materials (such as velvet), in addition to having a low albedo are also optically anisotropic, meaning that rotating the view of the material along the normal axis will yield different reflection characteristics. To adapt to that characteristic, the system camera may also rotate. Note that the degree or amount of anisotropy may be a function of frequency as well. For measuring optical properties, the system may utilize a square frame that can hold a swatch of material. Below the material is arranged a flat light source that is white-balanced. Above and below the material are placed RGB-D cameras that are capable of rotating in an arc from the normal axis the normal axis. In addition, there is a filter device that is capable of changing filters as desired; in one case these are a set of thin filters that have low absorption. See, for example FIG. 6, which is a diagram illustrating elements or components that may be used to obtain measurements of the anisotropy (or lack thereof) of a sample of material or fabric. In one embodiment, the system may operate by rotating one or more RGB-D cameras by 10-degree (or other) increments and swapping out the filters while measuring the light source. For some materials, measuring anisotropy may not be important (such as for plastic or similar types of materials), in which case a single view from the top is sufficient. This arrangement may also be used to measure surface specularity.

### Measurement of Tension, Stress, Strain

Applying a force to pull or stretch the fabric and measuring the distance pulled is slightly more complex than installing the pre-built tension sensors to measure the force. To pull the fabric and measure the distance the fabric is stretched, a servomotor can be used. Servomotors allow their position to be specifically set based upon the frequency and duty cycle of repeating pulses that are received by the servo. Using a spool of known circumference (c), the distance pulled (D_{pulled}) can be calculated based upon the proportion turned out of a full rotation:

$${D}_{pulled} = \frac{c δ θ}{2 π} = r δ θ$$

### Here

$$\frac{δ θ}{2 π}$$

represents the percentage of a full rotation that the servo has turned. With the servo it is possible to set it up so that the spool turns a small percentage of a rotation each time. The circumference of the spool used for the prototype is 120 mm, therefore if there are as few as 40 incremental rotational locations the system can fine tune the pull of the fabric to 3 mm. Finer control is also possible with servo motors, and the granularity will once again depend upon the type of fabric being stretched.

### Measurement of Physical Properties—Seams

Seams occur when two pieces of (potentially different) fabric are attached by stitching them together with thread. One way to simulate this effect is by including constraints between edge vertices. By measuring the stitch density, i.e. the number of stitches per unit length, the system can generate a set of constraints that accurately model the seam (for purposes of the inventive simulation, although other properties of a seam may be measured and used for other purposes; these include stitch pattern, strength of stitching thread, weave of material, relative positioning of the weave of the pieces being sewn together, etc.). Further, by destructively testing the seam, the system determines the maximum amount of force that the seam can withstand (tensile or shear) before failing. One effect of a seam is to attenuate a wave that travels across or along the seam. Further, a wave that is transmitted across a seam will behave like a wave traveling across the boundary between materials. The stitch density necessarily dictates the boundary conditions that must be satisfied by the wave at the seam.

### Application of Stretching Force or Friction

This is a destructive process where a known force is applied to the material from the normal axis and the break point is measured over the surface area. Note that because the material will be slightly elastic, this is important to take into consideration when considering the force. To increase the local force, a relatively sharp tip whose point area is greater than the weave area gap of the material should be used. The system will calculate the stress and strain tear point—at what point the material falls apart. The system can calculate both the pull and sheer values of the material—this is what it will take to rip the material with shear forces.

### Data Structures

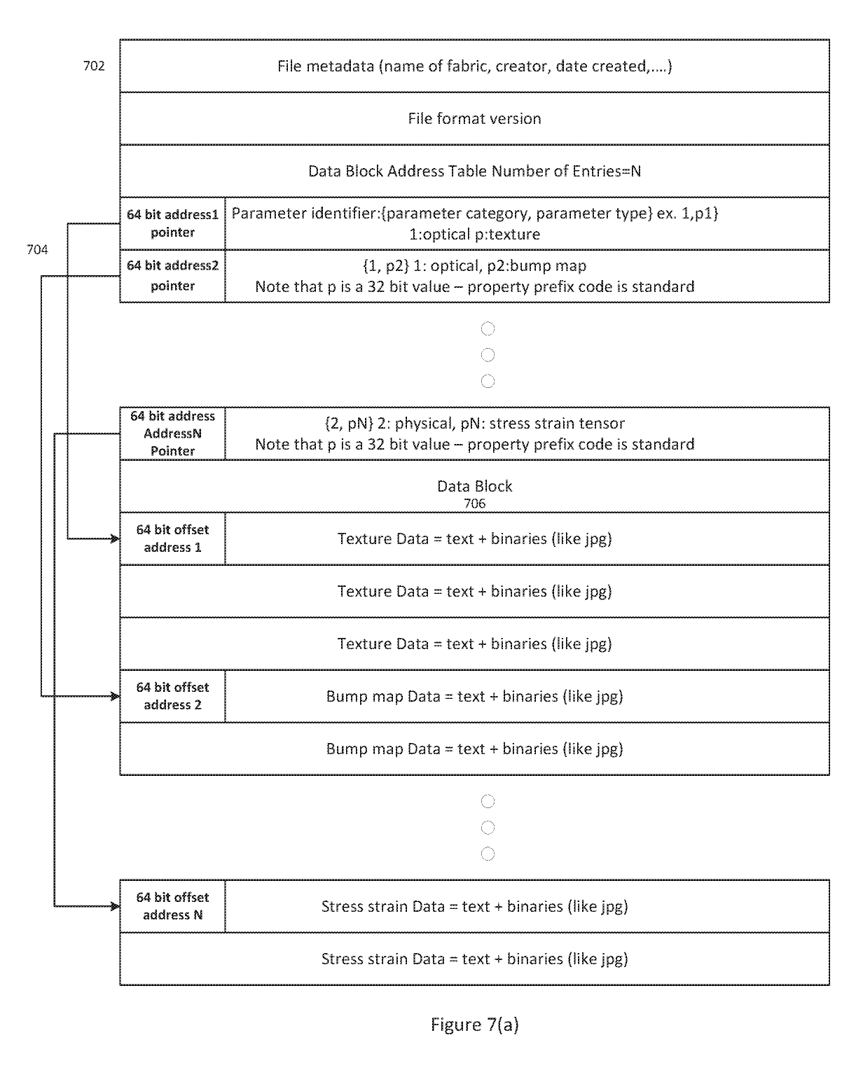

FIG. 7(a) is a diagram illustrating a data file format that is suitable for presenting the data measured or otherwise determined by an embodiment of the inventive system and methods so that it may be used by applications. As shown in the figure, a possible layout or memory block description may include one or more of the following records or information:
Metadata related to the material or fabric name/type (702);
Pointers to the location in the file of specific information regarding the material (704, e.g., optical, mechanical, stress/strain, etc.); and
Data values corresponding to specific characteristics (such as texture, stress/strain tensor, optical characteristics).
   Note that other data formats are possible; using XML (708), for example with a corresponding Zip file (710) containing the binaries, as suggested by the illustration shown in FIG. 7(b).

As described herein, characteristics of a garment or material that may be determined or used by the system include, but are not limited to including or required to include, the following:
Shader information: optical properties such as color, reflectivity, surface, subsurface scattering, occlusion, specularity, refraction;
Tension;
Rigidity;
Elasticity;
Normal map;
Fabric density;
Weight map;
Contour; and
Density.
   Additional properties may be added to the material, such as by introducing folds, crinkles, rips, etc. Once the parameters are entered, the material and garment can be assembled dynamically. The resulting garment image/model responds to wind, lighting conditions, and the underlying digital facsimile's movements. In addition, other parameters may be introduced, such as tautness and impact on skin elasticity.

Onboarding Materials (this represents examples of the data that may be used as inputs to a “model” of the behavior of the fabric or material)

### Load Material

Material name
Material properties (e.g., the set of material properties listed below)
   Stress/Strain tensor
   Channel (RGB) reflection, diffusion, diffraction, transmission, refraction
   “Roughness” index as measured by the piezoelectric scanner
   Surface normal map
   Warp factor (amount the material sags measured by the curvature of the sag)
   Material density (wave propagation velocity at different frequencies)
   Material dampening (the attenuation of a wave amplitude over the distance of the material)
Modify material (allows access to function for changing one or more material parameters)
Delete material (allows access to function for removing record of material)

As recognized by the inventors, when a user wears the garment, the garment should drape and fit the body in a realistic way; thus the visualization or representation of the garment should interact with the user's body visualization in a realistic way. To generate a photo-realistic garment that drapes accurately, several factors or aspects may need to be considered (although these are not necessarily limited to this list):
Cloth material properties (elasticity, thickness, wave propagation models through materials of varying density)
Cloth reflection properties (diffusion, Fresnel, occlusion, albedo, etc.)
Seam properties (ability to transmit waves, compression of cloth material, etc.)
Elastic bands (elasticity and inward force)
Interaction of different material types

Further, the garment should interact with the user representation in a realistic way; this may require consideration of one or more of:
Gravity
Garment pressure on a soft body like the skin
Fat vs. Muscle
Skin properties like elasticity
Skin Fresnel properties
Skin reflection properties
Skin scattering properties

In some embodiments, the inventive system will include one or more of the following elements, components, structures, or processes:
Means (elements; processes, structures or components) operable to hold a sample of fabric or material in place (e.g., clamps, locks, cables, connectors, etc.);
Means (elements, processes, structures or components) operable to stretch and/or twist material (e.g., controls, motors, structures to rotate at least a portion of the material, typically in a known manner and by an adjustable/incremental amount);
Means operable to determine optical properties, including
   Means operable to illuminate a sample of a fabric or material (e.g., mono or poly-chromatic LEDS or lasers);
   Means operable to detect a signal after interactions with the sample of fabric or material (e.g., optical sensors, narrow or broad spectrum, RGB-D camera);
Means operable to measure position or deflection of a location on the fabric sample under stress, torque, application of a stretching force (e.g., illumination source(s), elements to move/stress the sample by a known amount or degree, sensors (such as RGB-D camera) to detect position of specified location or feature prior to and after application of torque/stress, data processing to determine amount or degree of change between the “prior” and “after” measurements or images, etc.);
Means operable to determine one or more thermal properties of a material, such as heat transfer, or the temperature gradients across the material (e.g., source of heat, sensors to detect temperature or change in temperature at various locations (and if desired, as function of time) after application of heat, etc.); and
If needed, means (elements, processes; structures or components) operable to convert or translate data provide by a measuring device or sensor into a data format suitable for use as an input to a model or simulation (e.g., analog-to-digital conversion, filtering, signal processing, etc.).

Notice that certain of these elements, components or processes are not found in conventional material characterization systems, as those systems typically focus on the mechanical properties of a material (such as hardness, compressibility, flexibility). In addition, such systems do not readily produce output data in the purely digital format needed for use as part of a rendering process/pipeline. This is an important distinction because conventional systems do not capture the physical properties of materials and encode them into a format that can be understood/utilized by a physics engine in a rendering pipeline/system; nor do conventional systems capture certain of the types of data, such as the optical characteristics described herein, that are key to the appearance or simulation of a material or item, but which may not be as important for other uses.

In this regard, embodiments of the inventive system have the capability to determine certain optical properties (among others) of a material which are not typically able to be measured by conventional measurement systems (such as transparency, reflection, translucency, and/or anisotropy). Similarly, embodiments of the inventive system also have the capability to detect and measure certain properties of a fabric or material that are not typically used in generating a visualization, but that may provide useful information in creating a simulation or enhancing the realism of an image (such as thermal or non-optical frequency properties or behavior, surface roughness on a variety of scales, etc.).

The inability of conventional systems to produce certain types (or the desired quality) of data regarding materials has the result that rendering systems do not produce the degree of realism desired, and in some cases needed, to make decisions (or at least make better ones), or to generate sufficiently realistic simulations. As recognized by the inventors, this is because there is a disconnect between today's material analysis technologies and the modern digital world of gaming companies, CAD/CAM simulations, etc.

Because many current digital games, images and simulations are enhanced by taking into account the actual behavior of a material or item (and hence are more realistic), a system for measuring, determining, and collecting data regarding the behavior, appearance, or other properties of a material or item is highly desirable. Further, providing the data in a format that can be “digested” and used by a physics engine of a digital game or simulation is also highly desirable. Embodiments of the inventive system and methods were developed by the inventors to provide these capabilities.

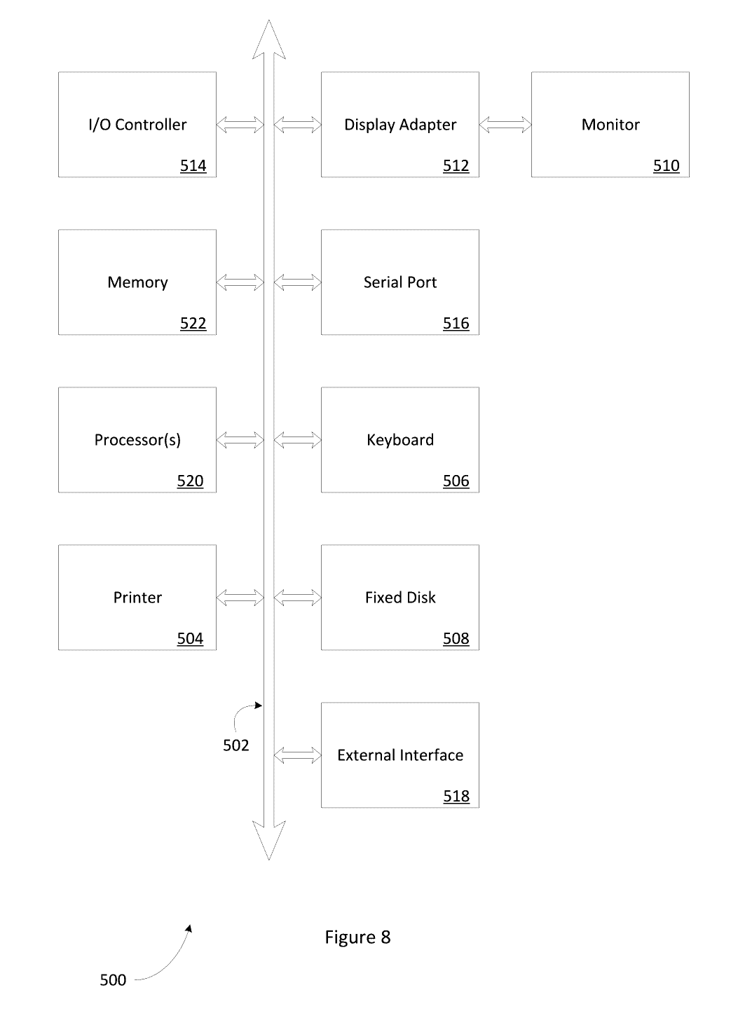

FIG. 8 is a diagram illustrating elements or components that may be present in a computer device or system configured to implement a method, process, function, or operation in accordance with an embodiment of the invention. As noted, in some embodiments, the inventive system and methods may be implemented in the form of an apparatus that includes a processing element and set of executable instructions. The executable instructions may be part of a software application and arranged into a software architecture. In general, an embodiment of the invention may be implemented using a set of software instructions that are designed to be executed by a suitably programmed processing element (such as a CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the inventive system and methods, such as for:
Determining certain optical properties of a material or item (including, but not limited to or requiring, transparency, reflection, translucency, and/or anisotropy);
   Controlling (if desired) elements or components used to illuminate a material or item (e.g., mono or poly-chromatic LEDS or lasers);
   Detecting an optical signal after interactions with a fabric or material, and applying specified filtering and/or processing operations to data representing the signal (e.g., optical sensors, narrow or broad spectrum, RGB-D camera, etc.);
   Detecting a non-optical signal (acoustic, radar, microwave, RF, thermal/heat) after interactions with a fabric or material, and applying specified filtering and/or processing operations to data representing the signal;
Determining the position or deflection of a location on a sample of fabric or material under stress, an applied torque, a stretching force (e.g., imaging elements and position locating structures or processes (such as a reference grid or indicator) for tracking the position or movement of a specified location as the fabric or material is stretched, twisted, stressed, pulled, etc.);
Controlling the force or forces applied to a sample of fabric or material by operation of a motor, rotating element, or similar elements; and
Determining the thermal properties of a fabric or material (e.g., heat transfer, temperature gradients across the material as a function of position and/or time in response to an applied source of heat).

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As described, the system, apparatus, methods, processes, functions, and/or operations for implementing an embodiment of the invention may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 8 is a diagram illustrating elements or components that may be present in a computer device or system 800 configured to implement a method, process, function, or operation in accordance with an embodiment of the invention. The subsystems shown in FIG. 5 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5 including a wide area network such as the Internet, a mouse input device, and/or a document scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using conventional or object-oriented techniques. The software code may be stored as a series of instructions, or commands on a computer readable medium, such as a flash-drive, random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A system for characterizing a material, comprising:
one or more components operable to hold a sample of the material;
one or more components operable to apply a stress, torque, or a stretching force to the sample in a known manner and by an adjustable amount;
one or more components operable to determine an optical property of the sample, the one or more components including
a source for illuminating the sample; and
a detector operable to detect a resulting signal after interaction of a signal from the source of illumination with the sample; and
one or more components operable to measure position or deflection of a location on the sample under the applied stress, torque, or stretching force.

2. The system of claim 1, wherein the one or more components operable to hold a sample of the material include a clamp, a lock, a cable, or a connector.

3. The system of claim 1, wherein the one or more components operable to apply a stress, torque, or a stretching force to the sample in a known manner and by an adjustable amount include a control, a motor, and a structure to rotate at least a portion of the material.

4. The system of claim 1, wherein the source for illuminating the sample is a LED or laser, and wherein the detector operable to detect a resulting signal after interaction of a signal from the source of illumination with the sample is a RGB-D camera.

5. The system of claim 1, wherein the one or more components operable to measure position or deflection of a location on the sample under the applied stress, torque, or stretching force include an illumination source, a sensor to detect a position of a specified location or feature of the sample prior to and after application of the stress, torque, or stretching force, and a data processing process to determine an amount or degree of change between images of the sample before and after application of the stress, torque, or stretching force.

6. The system of claim 1, further comprising one or more components operable to determine a thermal property of the sample, the thermal property including one or more of heat transfer, a temperature gradient across a region of the sample, or the temperature change at a location on the sample over time.

7. The system of claim 6, wherein the one or more components operable to determine a thermal property of the sample include a source of heat, and a sensor to detect temperature or a change in temperature at various locations of the sample after application of heat from the source.

8. The system of claim 5, further comprising a computer-implemented process to perform data processing operations on the output of one or more of the detectors or sensors to convert the output or outputs into a format in which the processed data may be provided as an input to a model or simulation of the material.

9. The system of claim 1, wherein the optical property of the sample that is determined is one or more of transparency, reflection, translucency, or anisotropy.

10. The system of claim 8, wherein the model or simulation is a model of an article of clothing that is fabricated at least in part from the material.

11. A system for generating a visualization of an avatar representing a person wearing an article of clothing, where the clothing is fabricated at least in part from a material, the system comprising:
an apparatus for characterizing the material, the apparatus including
one or more components operable to hold a sample of the material;
one or more components operable to apply a stress, torque, or a stretching force to the sample in a known manner and by an adjustable amount;
one or more components operable to determine an optical property of the sample, the one or more components including
a source for illuminating the sample; and
a detector operable to detect a resulting signal after interaction of a signal from the source of illumination with the sample; and
one or more components operable to measure position or deflection of a location on the sample under the applied stress, torque, or stretching force; and
one or more electronic processors programmed to implement one or more of
a process to perform data processing operations on the output of one or more of the detectors or sensors to convert the output or outputs into a format in which the processed data may be provided as an input to a model of the material;
a process to perform data processing operations using the converted output or outputs and the model of the material to generate an electronic representation of the article of clothing;
a process to perform data processing operations to generate an electronic representation of the person wearing the article of clothing; and
a process to perform data processing operations to generate a visualization of the person wearing the article of clothing.

12. The system of claim 11, wherein the one or more components operable to hold a sample of the material include a clamp, a lock, a cable; or a connector.

13. The system of claim 11, wherein the one or more components operable to apply a stress, torque, or a stretching force to the sample in a known manner and by an adjustable amount include a control, a motor, and a structure to rotate at least a portion of the material.

14. The system of claim 11, wherein the source for illuminating the sample is a LED or laser, and wherein the detector operable to detect a resulting signal after interaction of a signal from the source of illumination with the sample is a RGB-D camera.

15. The system of claim 11, wherein the one or more components operable to measure position or deflection of a location on the sample under the applied stress, torque, or stretching force include an illumination source, a sensor to detect a position of a specified location or feature of the sample prior to and after application of the stress, torque, or stretching force, and a data processing process to determine an amount or degree of change between images of the sample before and after application of the stress, torque, or stretching force.

16. The system of claim 11 wherein the process to perform data processing operations on the output of one or more of the detectors or sensors to convert the output or outputs into a format in which the processed data may be provided as an input to a model of the material operates to generate a stress tensor from the output of the one or more components operable to measure position or deflection of a location on the sample under the applied stress, torque, or stretching force.

17. The system of claim 11, wherein the process to perform data processing operations on the output of one or more of the detectors or sensors to convert the output or outputs into a format in which the processed data may be provided as an input to a model of the material operates to generate a tensor representing the reflectivity of the material a specified wavelength or set of wavelengths.

18. The system of claim 11, wherein the process to perform data processing operations to generate an electronic representation of the person wearing the article of clothing includes using data regarding the person, the data regarding the person including one or more of BMI, age, height, or weight.

19. The system of claim 11, wherein the optical property of the sample that is determined is one or more of transparency, reflection, translucency, or anisotropy.

20. The system of claim 11, wherein the process to perform data processing operations to generate a visualization of the person wearing the article of clothing includes generating the visualization of the person wearing the article of clothing under a set of environmental conditions.

21. The system of claim 20, further comprising a computer-implemented process to:
present the visualization of the person wearing the article of clothing under the set of environmental conditions to the person;
receive an input from the person identifying a change to the environmental conditions associated with the visualization; and
re-generate the visualization of the shopper wearing the article of clothing in the changed environmental conditions.
